(19) United States
(12) Patent Application Publication
(10) Pub. No.: US 2024/0385149 A1
(43) Pub. Date: Nov. 21, 2024

(54) POSITION SYNCHRONIZATION OF CHROMATOGRAPHY PUMPS DURING SAMPLE INJECTION

(71) Applicant: DIONEX SOFTRON GMBH, Germering (DE)

(72) Inventor: Christoph Strobl, Munich (DE)

(21) Appl. No.: 18/663,939

(22) Filed: May 14, 2024

(30) Foreign Application Priority Data
May 17, 2023 (DE) 102023113120.6

(51) Int. Cl. G01N 30/32; B01D 15/16

(52) U.S. Cl. CPC G01N 30/32; B01D 15/163; G01N 2030/324; G01N 2030/326

(57) ABSTRACT

A method comprising a first pump unit delivering a first flow of a first solvent at a first flow rate, and a second pump unit delivering a second flow of a second solvent at a second flow rate. At a first process stage of the first run when the first flow rate exceeds the second flow rate, the first pump unit assuming a first pump unit state, in the second run, at a first process stage of the second run, setting the first pump unit to the first pump unit state. At a second process stage of the first run when the second flow rate exceeds the first flow rate, the second pump unit assuming a second pump unit state, and in the second run, at a second process stage of the second run, setting the second pump unit to the second pump unit state.

### CROSS REFERENCE TO RELATE APPLICATIONS

This application claims the priority benefit under 35 U.S.C. § 119 to German Patent Application No. DE 10 2023 113 120.6 [Attorney Docket No. TP117557USUTL1 or P0087DE], filed on May 17, 2023, the disclosure of which is incorporated herein by reference.

### FIELD OF INVENTION

The invention lies in the field of chromatography and particularly in the field of liquid chromatography (LC) and high-performance liquid chromatography (HPLC). The goal of the present invention is to provide a high-pressure gradient pump system for HPLC. More particularly, the present invention relates to a pump system, a method performed in such a system and corresponding use of such a system.

### BACKGROUND OF THE INVENTION

Generally, a high-pressure gradient pump comprises several pump units, such as at least two pump units and typically two pump units. Each pump unit may be configured to deliver one type of fluid. Such a configuration creates a steady flow of liquid from each pump unit. For example, with a high-pressure gradient pump comprising two pump units, the two liquids are brought together after being conveyed by the units, for instance, by means of a T-connector, so that the two liquids can mix. The mixing ratio between the two liquids can be adjusted by the delivery speed of each unit. The sum of the two conveying speeds, neglecting effects such as volume excess or mixing heat or cold, gives the total conveying speed. The ratio of the two conveying speeds gives the mixing ratio. The sum and ratio of the conveying speeds can be changed independently or together. It is common to only change one of the two variables, and typically, only the mixing ratio. Each pump unit may comprise two piston units which generate the liquid flow for conveying according to the reciprocal displacement principle. The piston units can be connected in succession or in parallel. Motion profiles of the two piston units are superimposed so that the added piston speeds result in a desired delivery rate. Due to the reciprocal motion, in particular the motion for drawing liquid from a reservoir, individual piston units are not connected over the entire conveying period in such a way that they contribute to conveying, but are separated by valves, which in addition to the piston movement, leads to the volume of the enclosed liquid in the high-pressure gradient pump being variable over time.

For an analytical run, the pump usually controls a mixing ratio. At the start of the analytical run, one pump unit controls a small flow and the other a large flow, such as 5% versus 95% of the total flow. At the start of the analytical run, a so-called sampler injects a sample into the system. The sample may comprise components that are to be separated for the purpose of analysis, which may also be referred to as analytes. The separation takes place in a so-called column and is triggered by changing the mixing ratio. The separation of the sample is detected in a detector such as by absorption, fluorescence, and/or electrical detection. The detector then provides a time-resolved signal, and the separated sample components are then identified by peaks in the detection signal.

The analysis may comprise several analytical runs, which can be performed several times in succession, using as a measure the temporal position of the peaks with respect to the time of the start of the analysis, i.e., injection of the sample. The peaks can be characterized by their area in the time-signal diagram of the detector and/or the temporal position of the peak maximum. The latter criterion is used to determine the relative standard deviation when repeated several times. The smaller the relative standard deviation, the less the peak scatters around a certain point in time and the better the reproducibility.

### SUMMARY OF THE INVENTION

In a chromatographic analysis, the location of a peak maximum is determined by the analyte present in the sample and the uniformity of the flow of the high-pressure gradient pump. The high-pressure gradient pump may also simply be referred to as pump. The uniformity of the flow is disturbed by two effects from the pump: on the one hand, periodically repeating disturbances, which originate from the reciprocal piston movement, e.g., effectiveness of the valves, thermal effects, time-dependent leakage rates, and on the other hand, unique disturbances, like the injection of the sample by the sampler. During an analytical run, the sample is conveyed against a column for separation, for instance, a separation column. This may be performed at high pressure, e.g., up to 200 MPa may be typical in liquid chromatography. To get the sample into the system, an autosampler may pressurize the sample liquid, which is, for instance, done by compressing the sample liquid. Ideally, this is done before injection to the separation column, for example, by pre-compression. If this pre-compression is not carried out or not carried out completely, the sample is added to the fluidic system downstream of the pump with too little pressure, a one-time pressure drop occurs after the injection. The pressure collapse disturbs the uniformity of the flow, as do the regular disturbances caused by the reciprocal piston movement. As consequence, a relative standard deviation of the time of the peak maximum increases and the quality of the analysis worsens due to a poorer reproducibility.

There are several approaches proposed for injecting at arbitrary times. Some approaches accept the problems described above; other approaches synchronize the positions of the piston movements of the piston units with respect to the injection by the autosampler. However, for a pump with drives using so-called dependent drives difficulties arise. In a dependent drive, the piston movements are coupled together, i.e., one cannot move one piston without also moving the other, for example, this is the case when using a common camshaft with two cams on one axis, or a fixed gear. The two drives, i.e., the four piston units, should have a reproducible constant position of the four pistons at the time of injection by the autosampler. Known solutions are that drives with independent piston units move pistons into defined start positions before injection. For this purpose, the non-conveying piston is moved to the start position, the conveying piston interrupts its conveying movement at the time of injection by the autosampler, and the originally non-conveying piston takes over conveying for injection. This is done for both drives.

In other approaches, only one pump unit is synchronized with respect to the injection. In general, this is the slower pump unit of the two, as for the analysis it usually delivers an organic liquid. The pump unit with the organic liquid is chosen for this purpose because it has a greater influence in the periodic and one-time disturbances than the pump unit with strongly aqueous solution. It is typical for most such analytical runs that the pump unit with the organic liquid delivers at a low flow rate at the beginning of the analytical run and the other pump unit with strongly aqueous solution delivers at a high flow rate. This typical feature is used to distinguish the pump unit with the organic liquid from the pump unit with the highly aqueous solution and to identify it as the drive to be synchronized.

U.S. Pat. No. 5,897,781 A relates to a fluid delivery method and apparatus implementing active phasing to actively restore exact mechanical positions of driven components in a delivery system to reproduce the mechanical signature and hydraulic characteristics of the system from run to run without perturbing output flow. U.S. Pat. No. 5,897,781 A discloses a delivery system configured to drive pump pistons to a known position and to deliver fluid(s) at a known pressure, and includes a plurality of pump modules each including motor driven syringes having respective pistons configured to reciprocate under control of a control mechanism, wherein pump phasing is accomplished through a mechanism of compensation delivery of the syringes.

U.S. Pat. No. 8,375,772 B2 relates to a plurality of pumps for a liquid chromatography apparatus configured to mix eluents and to feed different eluents to the apparatus, wherein each of the pumps includes means for notifying an automatic sampler and a higher-level control unit that the specified timing of a liquid feeding cycle is reached, and a pump whose liquid feeding cycle is the slowest transmits own information so that the analysis is synchronized with a liquid feeding cycle.

JP-H-05-157743 A discloses a liquid chromatograph. To improve reproducibility of analysis, a control part determines the period of the operation of a moving-phase supply part by detection or computation. Injection of a sample is controlled on the basis of the determination.

U.S. Pat. No. 4,883,409 A relates to a pumping apparatus for delivering liquid at a high pressure, in particular for use in liquid chromatography, comprising two pistons which reciprocate in pump chambers, respectively. The output of the first pump chamber is connected via a valve to the input of the second pump chamber. The pistons are driven by linear drives and the stroke volume displaced by the piston is freely adjustable by corresponding control of the angle by which the shaft of the drive motor is rotated during a stroke cycle. U.S. Pat. No. 4,883,409 A also discloses a control circuitry, which is operative to reduce the stroke volume when the flow rate which can be selected by user at the user interface.

U.S. Pat. No. 7,917,250 B2 relates to a system, a device, and a method to mitigate the pressure disturbance associated with the injection of low-pressure analyte samples into a high-pressure HPLC fluid stream to enhance chromatographic performance related to retention time and reproducibility. In U.S. Pat. No. 7,917,250 B2, the injection event is coordinated with active pressure control of a binary solvent delivery system to virtually eliminate the customary pressure drop when the low-pressure loop is brought on line, which allows a consistent timing with the injection event of the mechanical position of the delivery pump pistons, and the start and subsequent gradient delivery generates reproducible results.

However, the explained-approaches known in the art comprises a plurality of disadvantages. A first solution requires an actuator with independent piston units, and this solution cannot be transferred to dependent actuators. In a second solution, the pump unit with the strongly aqueous solution not synchronized, so that a time-variable volume always remains in the pump and influences the analysis. Additionally, the slow pump unit may need a lot of time to reach the correct position to be synchronized. Various analytical methods do not require the pump unit to deliver only slowly, but its delivery may be zero at the time of injection. That is, the pump unit stands still and never moves to the position for synchronization. It is also not possible to move only one piston unit of this pump unit, as the dependent drive the other piston unit is also moved, which inevitably results in an undesired delivery of the pump unit and the mixing ratio is consequently disturbed. Even if the pump unit conveys slowly, so that the pump unit can reach a piston position for synchronization in a finite time, the problem remains, as this can take different lengths of time or very long, and as a result the analysis times is extended and the chemical environment in the column changes in different ways due to washout in the column. Hence, the approaches of the prior art still yield less reproducible analysis.

In light of the above, it is therefore an object of the present invention to overcome or at least to alleviated the shortcomings and disadvantages of the prior art. More particularly, it is an object of the present invention to provide a method and a corresponding pump system with an improved performance, in particular, with performance leading to more reproducible analytical runs, and less prompt to failure.

These objects are met by the present invention.

In a first aspect, the invention relates to a method comprising: a first pump unit delivering a first flow of a first solvent at a first flow rate, and a second pump unit delivering a second flow of a second solvent at a second flow rate, wherein the first flow rate and the second flow rate vary over time in a manner reoccurring in a plurality of runs, wherein the plurality of runs comprises at least a first run and a second run, wherein the method further comprises in the first run, at a first process stage of the first run when the first flow rate exceeds the second flow rate, the first pump unit assuming a first pump unit state, (a) in the second run, at a first process stage of the second run corresponding to the first process stage of the first run, wherein the first flow rate exceeds the second flow rate at the first process stage of the second run, setting the first pump unit to the first pump unit state, in the first run, at a second process stage of the first run when the second flow rate exceeds the first flow rate, the second pump unit assuming a second pump unit state, and (b) in the second run, at a second process stage of the second run corresponding to the second process stage of the second run, wherein the second flow rate exceeds the first flow rate at the second process stage of the second run, setting the second pump unit to the second pump unit state.

This is particularly advantageous, as it allows pumps using two dependent drives to be synchronized with respect to the moment of injection without the need of an excessively long time for the synchronization. In addition, the method is further advantageous, as it permits synchronizing even if a slow pump unit is to stop at the moment of injection. Synchronization of drives such as pistons is particularly advantageous, as it allows improving the reproducibility of analytical runs, and consequently, improving the reproducibly of analysis of samples. Moreover, synchronization of drives allows reducing errors of individual components of a pump system such as minimizing the influence of an increased leakage rate of aged valves. Hence, the quality of the analytical device comprising the pump system may be higher and more robust.

The method may be performed in a chromatography system comprising the first pump unit and the second pump unit.

In one embodiment, the first pump unit may comprise at least one piston and wherein the first pump unit state may be defined by a position of at least one of the at least one piston of the first pump unit. The at least one piston of the first pump unit may be a plurality of pistons and preferably two pistons.

In another embodiment, the second pump unit may comprise at least one piston and wherein the second pump unit state may be defined by a position of at least one of the at least one piston of the second pump unit. The at least one piston of the second pump unit may be a plurality of pistons and preferably two pistons.

The method may further comprise injecting a sample into an analytical path of the chromatography system in the first run and in the second run.

In one embodiment, for each run, the first process stage may be before injecting the sample into the analytical path.

In another embodiment, for each run, the first pump unit assumes the first pump unit state or may be set to the first pump unit state at a time preceding a respective injection time of the run by not more than 5 minutes, preferably by not more than 3 minutes, more preferable by not more than 1 minute.

In a further embodiment, in each run, a ratio between the second flow rate and the first flow rate may be highest at the second process stage.

Moreover, in each run, a ratio between the second flow rate and the first flow rate may be constant for an amount of time prior to the second process stage. The amount of time may be in the range of 1 minutes and 180 minutes, preferably between 3 minutes and 120 minutes, more preferably between 5 minutes and 60 minutes.

Furthermore, the plurality of runs may comprise more than two runs, wherein the method may further comprise performing steps corresponding to steps (a) and (b) for the runs after the second run. The runs may comprise at least 3 runs, preferably at least 7 runs.

Moreover, the chromatography system may be a liquid chromatography system. In another embodiment, the liquid chromatography system may be a high-performance liquid chromatography system.

The method may comprise varying the first flow rate over time in a manner reoccurring in a plurality of runs, wherein the first flow rate at an initial time t0 is different from the first flow rate at a subsequent time tn by at least 20% of the maximum of the first flow rate at the initial time t0 and the first flow rate at the subsequent time tn, preferably by at least 50% of this maximum, further preferably by at least 80% of this maximum.

For example, the first flow rate at an initial time t0 may be 5 ml/min, and the first flow rate at the time tn may be 0.5 ml/min. Thus, the described maximum is 5 ml/min, and the difference between the flow rates is 4.5 ml/min, i.e., 90% of the described maximum.

The method may comprise varying the second flow rate over time in a manner reoccurring in a plurality of runs, wherein the second flow rate at an initial time t0 is different from the second flow rate at a subsequent time tn by at least 20% of the maximum of the first flow rate at the initial time t0 and the first flow rate at the subsequent time tn, preferably by at least 50% of this maximum, further preferably by at least 80% of this maximum.

Additionally, or alternatively, the method may comprise providing a total flow rate between 0.001 ml/min and 20 ml/min, preferably between 0.005 ml/min and 15 ml/min, more preferably between 0.01 ml/min and 10 ml/min.

The chromatography system may be a liquid chromatography system and preferably a high-performance liquid chromatography system.

In one embodiment, the method may comprise the first pump unit delivering the first flow of the first solvent at a pressure exceeding ambient pressure by at least 100 bar, preferably by at least 1000 bar, more preferably by at least 1500 bar.

In another embodiment, the method may comprise the second pump unit delivering the second flow of the second solvent at a pressure exceeding ambient pressure by at least 100 bar, preferably by at least 1000 bar, more preferably by at least 1500 bar.

The method may comprise using at least one of: at least one polar solvent or at least one non-polar solvent.

In one embodiment, the method may comprise performing a normal phase chromatographic analytical run, wherein for the normal phase chromatographic analytical run the method may comprise using the at least one non-polar solvent.

In another embodiment, the method may comprise performing a reversed phase chromatographic analytical run, wherein for the reversed phase chromatographic analytical run the method may comprise using the at least one polar solvent and at least one less polar solvent.

Moreover, the method may comprise determining a current operating speed of the at least two pistons of the first pump unit, wherein the method may further comprise determining which of the at least two pistons comprises the faster current operating speed. Additionally or alternatively, the method may comprise determining a current operating speed of the at least two pistons of the second pump unit, wherein the method may further comprise determining which of the at least two pistons comprises the faster current operating speed.

The method may comprise prompting the first pump unit and/or the second pump unit to a synchronization position.

Furthermore, the method may comprise operating a sampling device comprised by the chromatography system. The sampling device may be a metering device. The method may comprise prompting the sampling device to a waiting stage and/or to an operating stage based on a response of the first pump unit and/or the second pump unit. Moreover, the method may comprise the metering device injecting the sample.

Moreover, the method may comprise executing an analytical run protocol.

In one embodiment, the method may comprise detecting a running speed of each of the at least one piston of first pump unit at a time t1, and determining which of the at least one piston of the first pump unit currently drives fastest.

In another embodiment, the method may comprise detecting a running speed of each of the at least one piston of the second pump unit at a time t1, and determining which of the at least one piston of the second pump unit currently drives fastest.

Moreover, the method may comprise detecting a measurement log reaching time t2; a running speed of the at least one piston of the first pump unit; and switching the at least one piston of the first pump unit back to a slow delivery mode.

In another embodiment, the method may comprise detecting a measurement log reaching time t2; a running speed of the at least one piston of the second pump unit; and switching the at least one piston of the second pump unit back to a slow delivery mode.

The method may comprise pausing the measurement log. Additionally or alternatively, the method may comprise resuming the measurement log.

The method may comprise detecting that the first pump unit reaches a position for synchronization. Additionally or alternatively, the method may comprise detecting that the second pump unit reaches a position for synchronization.

The method may comprise resuming the measurement log when the first pump unit has reached its position for synchronization. Additionally or alternatively, the method may comprise resuming the measurement log when the second pump unit has reached its position for synchronization.

For instance, at time t0 only one pump unit such as the first pump unit is synchronized until it reaches synchronization position, at time tn the other pump unit such the second pump unit is synchronized when it reaches it synchronization position. That is, at both times to and tn only one single drive at once is synchronized, however, in the same chromatographic run both pump units—e.g., the first pump unit and the second pump unit, are synchronized at different times.

The method may further comprise bidirectionally transmitting a signal between at least one of the first pump unit and the second pump unit, and the sampling device.

In one embodiment, the method may comprise transmitting a signal from the first pump unit to the sampling device, wherein the signal may comprise instructions so that the method may comprise the sampling device preparing for a subsequent injection.

It will be understood that preparing for a subsequent injection may comprise at least one of the steps of: the sampling device drawing up a volume of the sample, for example, from a sample reservoir, and after the sample is drawn, the sampling device moving to the injection site.

In another embodiment, the method may comprise transmitting a signal from the second pump unit to the sampling device, wherein the signal may comprise instructions so that the method may comprise the sampling device preparing for a subsequent injection.

The first pump unit may comprise an actuator with an independent piston unit. Additionally or alternatively, the first pump unit may comprise an actuator with a dependent piston unit. The second pump unit may comprise an actuator with an independent piston unit. Additionally or alternatively, the second pump unit may comprise an actuator with a dependent piston unit.

In one embodiment, the first pump unit may comprise an actuator with two independent piston units. In another embodiment, the second pump unit may comprise an actuator with two independent piston units.

Moreover, at least two pistons of an actuator of the first pump unit may be arranged in parallel. Additionally or alternatively, at least two pistons of an actuator of the first pump unit may be arranged in series. Furthermore, at least two pistons of an actuator of the second pump unit may be arranged in parallel. Additionally or alternatively, at least two pistons of an actuator of the second pump unit may be arranged in series.

In one embodiment, the actuator of the first pump unit and/or the second pump unit may comprise a spindle. In another embodiment, the actuator of the first pump unit and/or the second pump unit may comprise a camshaft.

The method may comprise establishing a fluid communication between the first pump unit and/or the second pump unit, and the sampling device.

At the first process stage of the second run, the first flow rate may be at least 60% of the sum of the first flow rate and the second flow rate, preferably at least 80% thereof. That is, the first pump unit may be synchronized at a process stage where it accounts for at least 60%, such as at least 80% of the total flow rate.

At the second process stage of the second run, the second flow rate may be at least 60% of the sum of the first flow rate and the second flow rate, preferably at least 80% thereof. That is, the second pump unit may be synchronized at a process stage where it accounts for at least 60%, such as at least 80% of the total flow rate.

The method may comprise finalizing a first analytical run, and carrying out the method as recited herein for performing a measurement in series, wherein the measurement in series may comprise at least two subsequent analytical runs.

In a second aspect, the invention relates to a pump system comprising a first pump unit, a second pump unit and a control unit, wherein the control unit is programmed to cause the pump system to perform the method as recited herein.

That is, the control unit is configured to cause the pump system to perform the method.

In one embodiment, the first pump unit may comprise at least one piston. The at least one piston of the first pump unit may be a plurality of pistons. The plurality of pistons may comprise a double piston configuration.

In a further embodiment, the second pump unit may comprise at least one piston. The at least one piston of the second pump unit may be a plurality of pistons. The plurality of pistons may comprise a double piston configuration.

Each of the at least one piston of the first pump unit and/or the second pump unit may comprise a piston with a variable accommodation volume.

In one embodiment, the double piston configuration of the first pump unit may be arranged in parallel. Additionally or alternatively, the double piston configuration of the first pump unit may be arranged in series.

In a further embodiment, the double piston configuration of the second pump unit may be arranged in parallel. Additionally or alternatively, the double piston configuration the second pump unit may be arranged in series.

Moreover, the first pump unit pump may be a pump unit for liquid chromatography. Additionally or alternatively, the second pump unit may be a pump unit for liquid chromatography.

In one embodiment, the first pump unit may be a pump unit for high performance liquid chromatography. Additionally or alternatively, the second pump unit pump may be a pump for high performance liquid chromatography.

In one embodiment, a state of the first pump unit may be defined by a position of at least one of the at least one piston of the first pump unit. Additionally or alternatively, a state of the second pump unit may be defined by a position of at least one of the at least one piston of the second pump unit. Each of the at least one piston of the first pump unit may be configured to operate unsynchronized respect to each other. In a further embodiment, at least two of the at least one piston of the first pump unit may be configured to operate synchronously. Additionally or alternatively, each of the at least one piston of the second pump unit may be configured to operate unsynchronized respect to each other. Moreover, at least two of the at least one piston of the second pump unit may be configured to operate synchronously.

In a third aspect, the invention relates to a chromatography system comprising the pump system as recited herein.

In one embodiment, the system may comprise a sampling device. The sampling device may be a metering device.

Additionally or alternatively, the chromatography system may comprise at least one column. The at least one column may comprise at least one separation column. The at least one column may comprise at least one trap column.

Furthermore, the system may comprise at least one mixer unit. Additionally or alternatively, the system may comprise at least one control unit bidirectionally connected to at least one component of the system.

In one embodiment, the system may be a liquid chromatography system. The liquid chromatography system may be a high-performance liquid chromatography system.

In a further embodiment, the system may be configured to be pressurized to a first pressure exceeding ambient pressure by at least 100 bar, preferably by at least 1000 bar, more preferably by at least 1500 bar.

Moreover, the system may comprise: a sample pick-up means, a seat for receiving the sample pick-up means, and at least one distributor valve comprising a plurality of ports and a plurality of connecting element for changeably connecting the ports of the at least one distributor valve.

In one embodiment, the sampling device may be adapted to suck in a sample. Additionally or alternatively, the sample pick-up means may be configured to be fluidly connected to the seat.

Furthermore, the system may be adapted to assume a configuration, wherein the at least one trap column may be isolated from ambient atmosphere and may be pressurized to a first trap column pressure exceeding ambient pressure.

In one embodiment, the system may be configured to pressurize at least one of the at least one column to a first column pressure by means of the metering device. Additionally or alternatively, the system may be configured to fluidly connect the at least one trap column to the at least one separation column.

The system may further be adapted to assume a configuration to depressurize at least one of the at least one column. Additionally or alternatively, the system may be adapted so that at least one of the at least one column may be depressurized by means of the metering device.

In one embodiment, the system may further comprise a waste reservoir. Additionally or alternatively, the system may be configured to assume a configuration wherein the waste reservoir may be fluidly connected to at least one of the at least one column.

The metering device may comprise a first port and a second port for fluidly connecting the metering device to other components comprised by the system. Each port comprised by the metering device may be configured to be selectively opened and closed. In a further embodiment, the system may be configured to allow a solvent to be introduced into the metering device through the first port, and to allow the solvent to be expelled from the metering device through the second port.

The system may be adapted to assume any of the configurations as recited herein.

The system may further comprise a detector unit. Additionally or alternatively, the detector unit may comprise a mass spectrometer.

In one embodiment, the at least on control unit may be bidirectionally connected to the pump system. In another embodiment, the at least one control unit may be bidirectionally connected to the sampling device.

At least two components of the chromatography system may be directly bidirectionally connected.

The system may be configured to assume a configuration wherein at least one of the at least one separation column may be fluidly connected to the detector unit.

The system may be configured to carry out the method as recited herein.

The first pump and second pump unit may be configured to be connected to at least one component of the chromatography system as recited herein. At least of the first pump unit and the second pump unit may be fluidly connected to at least one component of the chromatography system as recited herein.

In one embodiment, the first pump unit and the second pump unit may be configured to bidirectionally communicate among each other.

Furthermore, the control unit may be configured to control the communication between the first pump unit and the second pump unit.

In a further embodiment, the first pump unit and the second pump unit may be configured to directly bidirectionally communicate among each other.

In one embodiment, the method may utilize the pump system as recited herein. Additionally or alternatively, the method may utilize the chromatography system as recited herein.

In another embodiment, the pump system may be configured to carry out the method as recited herein.

In a fourth aspect, the invention relates to a computer program product comprising instructions, which, when the computer program is performed by a control unit of a pump system, cause the control unit to control the pump system to perform the method as recited herein.

In one embodiment, the invention relates to a computer-readable storage having stored thereon the computer program product as recited herein. In a further embodiment, the invention relates to a data carrier signal carrying the computer program product as recited herein.

In relation to other solution known in the art, the present invention is particularly advantageous, as it permits improving the synchronization of both drives of a pump unit comprising dependent drives without increasing the analysis run times. Moreover, the approach of the present invention is particularly advantageous, as it improves synchronization of piston positions of a pump unit, for example, an HPLC pump, with respect to the injection timing of a sampling device. This is particularly beneficial, as it yields more reproducible analytical runs and consequently, analysis with higher reproducibility without an increasing of the preparation time beyond measure.

Furthermore, the approach of the present invention is also advantageous, as it allows reducing, if not eliminating, the influence of time dependence of the volume in the pump of the disturbances. Embodiments of the present invention allow this by positioning the pistons of the pump units always in the same position at the time of injection, which permits the pump unit then always having the same and reproducible volumes enclosed at all times. Consequently, all disturbances have always the same effect, which is beneficial as the disturbances always have a reproducible influence on the peak maximum, occurring always at the same time. That is, the approach of embodiments of the present invention leads to analytical runs with higher reproducibility.

The present technology is also defined by the following numbered embodiments.

Below, method embodiments will be discussed. These embodiments are abbreviated by the letter “M” followed by a number. When reference is herein made to a method embodiment, those embodiments are meant.

M1. A method comprising
a first pump unit delivering a first flow of a first solvent at a first flow rate, and
a second pump unit delivering a second flow of a second solvent at a second flow rate,
wherein the first flow rate and the second flow rate vary over time in a manner reoccurring in a plurality of runs, wherein the plurality of runs comprise at least a first run and a second run,
wherein the method further comprises
in the first run, at a first process stage of the first run when the first flow rate exceeds the second flow rate, the first pump unit assuming a first pump unit state,
(a) in the second run, at a first process stage of the second run corresponding to the first process stage of the first run, wherein the first flow rate exceeds the second flow rate at the first process stage of the second run, setting the first pump unit to the first pump unit state,
in the first run, at a second process stage of the first run when the second flow rate exceeds the first flow rate, the second pump unit assuming a second pump unit state, and
(b) in the second run, at a second process stage of the second run corresponding to the second process stage of the second run, wherein the second flow rate exceeds the first flow rate at the second process stage of the second run, setting the second pump unit to the second pump unit state.

M2. The method according to the preceding embodiment, where the method is performed in a chromatography system comprising the first pump unit and the second pump unit.

M3. The method according to any of the preceding embodiments, wherein the first pump unit comprises at least one piston and wherein the first pump unit state is defined by a position of at least one of the at least one piston of the first pump unit.

M4. The method according to the preceding embodiments, wherein the at least one piston of the first pump unit is a plurality of pistons and preferably two pistons.

M5. The method according to any of the preceding embodiments, wherein the second pump unit comprises at least one piston and wherein the second pump unit state is defined by a position of at least one of the at least one piston of the second pump unit.

M6. The method according to the preceding embodiments, wherein the at least one piston of the second pump unit is a plurality of pistons and preferably two pistons.

M7. The method according to any of the preceding embodiments with the features of embodiment M2, wherein the method further comprises injecting a sample into an analytical path of the chromatography system in the first run and in the second run.

M8. The method according to the preceding embodiment, wherein for each run, the first process stage is before injecting the sample into the analytical path.

M9. The method according to the preceding embodiment, wherein for each run, the first pump unit assumes the first pump unit state or is set to the first pump unit state at a time preceding a respective injection time of the run by not more than 5 minutes, preferably by not more than 3 minutes, more preferable by not more than 1 minute.

M10. The method according to any of the preceding embodiments, wherein in each run, a ratio between the second flow rate and the first flow rate is highest at the second process stage.

M11. The method according to any of the preceding embodiments, wherein in each run, a ratio between the second flow rate and the first flow rate is constant for an amount of time prior to the second process stage.

M12. The method according to the preceding embodiment, wherein the amount of time is in the range of 1 minutes and 180 minutes, preferably between 3 minutes and 120 minutes, more preferably between 5 minutes and 60 minutes.

M13. The method according to any of the preceding embodiments, wherein the plurality of runs comprises more than two runs, wherein the method further comprises performing steps corresponding to steps (a) and (b) for the runs after the second run.

M14. The method according to the preceding embodiment, wherein the runs comprise at least 3 runs, preferably at least 7 runs.

M15. The method according to any of the preceding embodiments and with the features of embodiment M2, wherein the chromatography system is a liquid chromatography system.

M16. The method according to the preceding embodiment, wherein the liquid chromatography system is a high-performance liquid chromatography system.

M17. The method according to any of the preceding embodiments, wherein the method comprises varying the first flow rate over time in a manner reoccurring in a plurality of runs, wherein the first flow rate at an initial time t0 is different from the first flow rate at a subsequent time tn by at least 20% of the maximum of the first flow rate at the initial time t0 and the first flow rate at the subsequent time tn, preferably by at least 50% of this maximum, further preferably by at least 80% of this maximum.

M18. The method according to any of the preceding embodiment, wherein the method comprises varying the second flow rate over time in a manner reoccurring in a plurality of runs, wherein the second flow rate at an initial time t0 is different from the second flow rate at a subsequent time tn by at least 20% of the maximum of the first flow rate at the initial time t0 and the first flow rate at the subsequent time tn, preferably by at least 50% of this maximum, further preferably by at least 80% of this maximum.

M19. The method according to any of the preceding embodiments, wherein the method comprises providing a total flow rate between 0.001 ml/min and 20 ml/min, preferably between 0.005 ml/min and 15 ml/min, more preferably between 0.01 ml/min and 10 ml/min.

M20. The method according to any of the preceding embodiments with the features of embodiment M2, wherein the chromatography system is a liquid chromatography system and preferably a high-performance liquid chromatography system.

M21. The method according to any of the preceding embodiments, wherein the method comprises the first pump unit delivering the first flow of the first solvent at a pressure exceeding ambient pressure by at least 100 bar, preferably by at least 1000 bar, more preferably by at least 1500 bar.

M22. The method according to any of the preceding embodiments, wherein the method comprises the second pump unit delivering the second flow of the second solvent at a pressure exceeding ambient pressure by at least 100 bar, preferably by at least 1000 bar, more preferably by at least 1500 bar.

M23. The method according to any of the preceding embodiments, wherein the method comprises using at least one of: at least one polar solvent or at least one non-polar solvent.

M24. The method according to the preceding embodiment, wherein the method comprises performing a normal phase chromatographic analytical run, wherein for the normal phase chromatographic analytical run the method comprises using the at least one non-polar solvent.

M25. The method according to embodiment M23, wherein the method comprises performing a reversed phase chromatographic analytical run, wherein for the reversed phase chromatographic analytical run the method comprises using the at least one polar solvent and at least one less polar solvent.

M26. The method according to any of the preceding embodiments and with the features of embodiment M4, wherein the method comprises determining a current operating speed of the at least two pistons of the first pump unit, wherein the method further comprises determining which of the at least two pistons comprise the faster current operating speed.

M27. The method according to any of the preceding embodiments and with the features of embodiment M6, wherein the method comprises determining a current operating speed of the at least two pistons of the second pump unit, wherein the method further comprises determining which of the at least two pistons comprise the faster current operating speed.

M28. The method according to any of the preceding embodiments, wherein the method comprises prompting the first pump unit and/or the second pump unit to a synchronization position.

M29. The method according to any of the preceding embodiments and with the features of embodiment M2, wherein the method comprises operating a sampling device comprised by the chromatography system.

M30. The method according to the preceding embodiment, wherein the sampling device is a metering device.

M31. The method according to any of the 2 preceding embodiments, wherein the method comprises prompting the sampling device to a waiting stage and/or to an operating stage based on a response of the first pump unit and/or the second pump unit.

M32. The method according to any of the preceding embodiments, and with the features of embodiments M7 and M30, wherein the method comprises the metering device injecting the sample.

M33. The method according to any of the preceding embodiments, wherein the method comprises executing an analytical run protocol.

M34. The method according to any of the preceding embodiments with the features of embodiment M3, wherein the method comprises
detecting a running speed of each of the at least one piston of first pump unit at a time t1, and
determining which of the at least one piston of the first pump unit currently drives fastest.

M35. The method according to any of the preceding embodiments with the features of embodiment M5, wherein the method comprises
detecting a running speed of each of the at least one piston of the second pump unit at a time t1, and
determining which of the at least one piston of the second pump unit currently drives fastest.

M36. The method according to any of the preceding embodiments, wherein the method comprises detecting
a measurement log reaching time t2;
a running speed of the at least one piston of the first pump unit; and
switching the at least one piston of the first pump unit back to a slow delivery mode.

M37. The method according to any of the preceding embodiments, wherein the method comprises detecting
a measurement log reaching time t2;
a running speed of the at least one piston of the second pump unit; and
switching the at least one piston of the second pump unit back to a slow delivery mode.

M38. The method according to any of the preceding embodiments, wherein the method comprises pausing the measurement log.

M39. The method according to any of the preceding embodiments, wherein the method comprises resuming the measurement log.

M40. The method according to any of the preceding embodiments, wherein the method comprises detecting that the first pump unit reaches a position for synchronization.

M41. The method according to any of the preceding embodiments, wherein the method comprises detecting that the second pump unit reaches a position for synchronization.

M42. The method according to the any of the preceding embodiments and with the features of embodiment M39 and M40, wherein the method comprises resuming the measurement log when the first pump unit has reached its position for synchronization.

M43. The method according to any of the preceding embodiments with the features of embodiments M39 and M41, wherein the method comprises resuming the measurement log when the second pump unit has reached its position for synchronization.

M44. The method according to any of the preceding embodiments and with the features of embodiment M29, wherein the method further comprises bidirectionally transmitting a signal between at least one of the first pump unit and the second pump unit, and the sampling device.

M45. The method according to the preceding embodiment, wherein the method comprises transmitting a signal from the first pump unit to the sampling device, wherein the signal comprises instructions so that the method comprises the sampling device preparing for a subsequent injection.

M46. The method according to any of the two the preceding embodiments, wherein the method comprises transmitting a signal from the second pump unit to the sampling device, wherein the signal comprises instructions so that the method comprises the sampling device preparing for a subsequent injection.

M47. The method according to any of the preceding embodiments and with the features of embodiment M4, wherein the first pump unit comprises an actuator with an independent piston unit.

M48. The method according to any of the preceding embodiments and with the features of embodiment M4, wherein the first pump unit comprises an actuator with a dependent piston unit.

M49. The method according to any of the preceding embodiments and with the features of embodiment M6, wherein the second pump unit comprises an actuator with an independent piston unit.

M50. The method according to any of the preceding embodiments and with the features of embodiment M6, wherein the second pump unit comprises an actuator with a dependent piston unit.

M51. The method according to embodiment M35, wherein the first pump unit comprises an actuator with two independent piston units.

M52. The method according to embodiment M37, wherein the second pump unit comprises an actuator with two independent piston units.

M53. The method according to any of the preceding embodiments and with the features of embodiment M4, wherein at least two pistons of an actuator of the first pump unit are arranged in parallel.

M54. The method according to any of the preceding embodiments and with the features of embodiment M4, wherein at least two pistons of an actuator of the first pump unit are arranged in series.

M55. The method according to any of the preceding embodiments and with the features of embodiment M6, wherein at least two pistons of an actuator of the second pump unit are arranged in parallel.

M56. The method according to any of the preceding embodiments and with the features of embodiment M6, wherein at least two pistons of an actuator of the second pump unit are arranged in series.

M57. The method according to any of the preceding embodiments, wherein the actuator of the first pump unit and/or the second pump unit comprises a spindle.

M58. The method according to any of the preceding embodiments, wherein the actuator of the first pump unit and/or the second pump unit comprises a camshaft.

M59. The method according to any of the preceding embodiments and with the features of embodiment M29, wherein the method comprises establishing a fluid communication between the first pump unit and/or the second pump unit, and the sampling device.

M60. The method according to any of the preceding embodiments, wherein at the first process stage of the second run, the first flow rate is at least 60% of the sum of the first flow rate and the second flow rate, preferably at least 80% thereof.

M61. The method according to any of the preceding embodiments, wherein at the second process stage of the second run, the second flow rate is at least 60% of the sum of the first flow rate and the second flow rate, preferably at least 80% thereof.

M62. The method according to any of the preceding method embodiments, wherein the method comprises finalizing a first analytical run, and carrying out the method according to any of the preceding method embodiments for performing a measurement in series, wherein the measurement in series comprises at least two subsequent analytical runs.

Below, pump system embodiments will be discussed. These embodiments are abbreviated by the letter “P” followed by a number. When reference is herein made to a pump system embodiment, those embodiments are meant.

P1. A pump system comprising a first pump unit, a second pump unit and a control unit, wherein the control unit is programmed to cause the pump system to perform the method according to any of the preceding method embodiments.

That is, the control unit is configured to cause the pump system to perform the method.

P2. The pump system according to the preceding embodiment, wherein the first pump unit comprises at least one piston.

P3. The pump system according to the preceding embodiment, wherein the at least one piston of the first pump unit is a plurality of pistons.

P4. The pump system according to the preceding embodiment, wherein the plurality of pistons comprises a double piston configuration.

P5. The pump system according to any of the preceding pump system embodiments, wherein the second pump unit comprises at least one piston.

P6. The pump system according to the preceding embodiment, wherein the at least one piston of the second pump unit is a plurality of pistons.

P7. The pump system according to the preceding embodiment, wherein the plurality of pistons comprises a double piston configuration.

P8. The pump system according to any of the preceding pump system embodiments, wherein each of the at least one piston of the first pump unit and/or the second pump unit comprises a piston with a variable accommodation volume.

P9. The pump system according to any of the preceding pump system embodiments and with the features of embodiment P4, wherein the double piston configuration of the first pump unit is arranged in parallel.

P10. The pump system according to any of the preceding pump system embodiments and with the features of embodiment P4, wherein the double piston configuration of the first pump unit is arranged in series.

P11. The pump system according to any of the preceding pump system embodiments and with the features of embodiment P7, wherein the double piston configuration of the second pump unit is arranged in parallel.

P12. The pump system according to any of the preceding pump system embodiments and with the features of embodiment P7, wherein the double piston configuration the second pump unit is arranged in series.

P13. The pump system according to any of the preceding pump system embodiments, wherein the first pump unit pump is a pump unit for liquid chromatography.

P14. The pump system according to any of the preceding pump system embodiments, wherein the second pump unit is a pump unit for liquid chromatography.

P15. The pump system according to any of the preceding pump system embodiments, wherein the first pump unit is a pump unit for high performance liquid chromatography.

P16. The pump system according to any of the preceding pump system embodiments, wherein the second pump unit pump is a pump for high performance liquid chromatography.

P17. The pump system according to any of the preceding pump system embodiments, wherein a state of the first pump unit is defined by a position of at least one of the at least one piston of the first pump unit.

P18. The pump system according to any of the preceding pump system embodiments, wherein a state of the second pump unit is defined by a position of at least one of the at least one piston of the second pump unit.

P19. The pump system according to any of the preceding pump system embodiments and with the features of embodiment P2, wherein each of the at least one piston of the first pump unit is configured to operate unsynchronized respect to each other.

P20. The pump system according to any of the preceding pump system embodiments and with the features of embodiment P2, wherein at least two of the at least one piston of the first pump unit are configured to operate synchronously.

P21. The pump system according to any of the preceding pump system embodiments and with the features of embodiment P5, wherein each of the at least one piston of the second pump unit is configured to operate unsynchronized respect to each other.

P22. The pump system according to any of the preceding pump system embodiments and with the features of embodiment P5, wherein at least two of the at least one piston of the second pump unit are configured to operate synchronously.

Below, chromatography system embodiments will be discussed. These embodiments are abbreviated by the letter “S” followed by a number. When reference is herein made to a chromatography system embodiment, those embodiments are meant.

S1. A chromatography system comprising the pump system according to any of the preceding pump system embodiments.

S2. The chromatography system according to the preceding embodiment, wherein the system comprises a sampling device.

S3. The chromatography system according to the preceding embodiment, wherein the sampling device is a metering device.

S4. The chromatography system according to any of the preceding system embodiments, wherein the chromatography system comprises at least one column.

S5. The chromatography system according to the preceding embodiment, wherein the at least one column comprises at least one separation column.

S6. The chromatography system according to any of the 2 preceding embodiments, wherein the at least one column comprises at least one trap column.

S7. The chromatography system according to any of the preceding system embodiments, wherein the system comprises at least one mixer unit.

S8. The chromatography system according to any of the preceding system embodiments, wherein the system comprises at least one control unit bidirectionally connected to at least one component of the system.

S9. The chromatography system according to any of the preceding system embodiments, wherein the system is a liquid chromatography system.

S10. The chromatography system according to the preceding embodiment, wherein the liquid chromatography system is a high-performance liquid chromatography system.

S11. The chromatography system according to any of the preceding system embodiments, wherein the system is configured to be pressurized to a first pressure exceeding ambient pressure by at least 100 bar, preferably by at least 1000 bar, more preferably by at least 1500 bar.

S12. The chromatography system according to any of the preceding system embodiments, wherein the system comprises
a sample pick-up means,
a seat for receiving the sample pick-up means, and
at least one distributor valve comprising a plurality of ports and a plurality of connecting element for changeably connecting the ports of the at least one distributor valve.

S13. The chromatography system according to any of the preceding system embodiments and with the features of embodiment S2, wherein the sampling device is adapted to suck in a sample.

S14. The chromatography system according to any of the 2 preceding embodiments, wherein the sample pick-up means is configured to be fluidly connected to the seat.

S15. The chromatography system according to any of the 3 preceding embodiments and with the features of embodiment S6, wherein the system is adapted to assume a configuration, wherein the at least one trap column is isolated from ambient atmosphere and is pressurized to a first trap column pressure exceeding ambient pressure.

S16. The chromatography system according to any of the preceding system embodiments and with the features of any of embodiments S4 to S6, wherein the system is configured to pressurize at least one of the at least one column to a first column pressure by means of the metering device.

S17. The chromatography system according to any of the preceding system embodiments and with the features of embodiments S4 to S6, wherein the system is configured to fluidly connect the at least one trap column to the at least one separation column.

S18. The chromatography system according to any of the preceding system embodiments and with the features of embodiments S4 to S6, wherein the system is further adapted to assume a configuration to depressurize at least one of the at least one column.

S19. The chromatography system according to the preceding embodiment and with the features of embodiments S3 to S6, wherein the system is adapted so that at least one of the at least one column is depressurized by means of the metering device.

S20. The chromatography system according to any of the preceding system embodiments, wherein the system further comprises a waste reservoir.

S21. The chromatography system according to the preceding embodiment and with the features of embodiments S4 to S6, wherein the system is configured to assume a configuration wherein the waste reservoir is fluidly connected to at least one of the at least one column.

S22. The chromatography system according to any of the preceding system embodiments and with the features of embodiment S3, wherein the metering device comprises a first port and a second port for fluidly connecting the metering device to other components comprised by the system.

S23. The chromatography system according to the preceding embodiment, wherein each port comprised by the metering device is configured to be selectively opened and closed.

S24. The chromatography system according to the 2 preceding embodiments, wherein the system is configured to allow a solvent to be introduced into the metering device through the first port, and to allow the solvent to be expelled from the metering device through the second port.

S25. The chromatography system according to any of the preceding system embodiments, wherein the system is adapted to assume any of the configurations defined in any of the method embodiments.

S26. The chromatography system according to any of the preceding system embodiments, wherein the system further comprises a detector unit.

S27. The chromatography system according to the preceding embodiment, wherein the detector unit comprises a mass spectrometer.

S28. The chromatography system according to any of the preceding system embodiments and with the features of embodiment S8, wherein the at least on control unit is bidirectionally connected to the pump system.

S29. The chromatography system according to any of the preceding system embodiments and with the features of embodiments S2 and S8, wherein the at least one control unit is bidirectionally connected to the sampling device.

S30. The chromatography system according to any of the preceding system embodiment, wherein at least two components of the chromatography system are directly bidirectionally connected.

S31. The chromatography system according to any of the preceding embodiments with the features of embodiments S5 and S26, wherein the system is configured to assume a configuration wherein at least one of the at least one separation column is fluidly connected to the detector unit.

S32. The chromatography system according to any of the preceding system embodiments, wherein the system is configured to carry out the method according to any of the preceding method embodiments.

P23. The pump system according to any of the preceding pump system embodiments, wherein the first pump and second pump unit are configured to be connected to at least one component of the chromatography system according to any of the preceding chromatography system embodiments.

P24. The pump system according to the preceding embodiment, wherein at least of the first pump unit and the second pump unit are fluidly connected to at least one component of the chromatography system according to any of the preceding chromatography system embodiments.

P25. The pump system according to any of the preceding pump system embodiments, wherein the first pump unit and the second pump unit are configured to bidirectionally communicate among each other.

P26. The pump system according to the preceding embodiment, wherein the control unit is configured to control the communication between the first pump unit and the second pump unit.

P27. The pump system according to embodiment P23, wherein the first pump unit and the second pump unit are configured to directly bidirectionally communicate among each other.

M61. The method according to any of the preceding method embodiments, wherein the method utilizes the pump system according to any of the preceding pump system embodiments.

M62. The method according to any of the preceding method embodiments, wherein the method utilizes the chromatography system according to any of the preceding chromatography system embodiments.

P28. The pump system according to any of the preceding pump system embodiments, wherein pump system is configured to carry out the method according to any of the preceding method embodiments.

Below, computer program product embodiments will be discussed. These embodiments are abbreviated by the letter “C” followed by a number. When reference is herein made to a computer program product embodiment, those embodiments are meant.

C1. Computer program product comprising instructions, which, when the computer program is performed by a control unit of a pump system, cause the control unit to control the pump system to perform the method according to any of the preceding method embodiments.

C2. A computer-readable storage having stored thereon the computer program product of embodiment C1.

C3. A data carrier signal carrying the computer program product of embodiment C1.

### DESCRIPTION OF FIGURES

The present invention will now be described with reference to the accompanying drawings which illustrate embodiments of the invention. These embodiments should only exemplify, but not limit, the present invention.

FIG. 1 depicts component of an analytical system according to embodiments of the present invention;

FIG. 2 depicts a pump according to embodiments of the present invention;

FIG. 3 an example of a sequence of a mixing ratio vs time according to embodiments of the present invention;

FIG. 4 depicts a synchronization of a drive conveying fluids over time according to embodiments of the present invention;

FIGS. 5A, 5B depict examples of a piston position while performing gradient analysis according to embodiments of the present invention;

FIGS. 6A, 6B depict examples of a synchronized piston position while performing gradient analysis according to embodiments of the present invention.

### DETAILED DESCRIPTION

It is noted that not all the drawings carry all the reference signs. Instead, in some of the drawings, some of the reference signs have been omitted for sake of brevity and simplicity of illustration. Embodiments of the present invention will now be described with reference to the accompanying drawings.

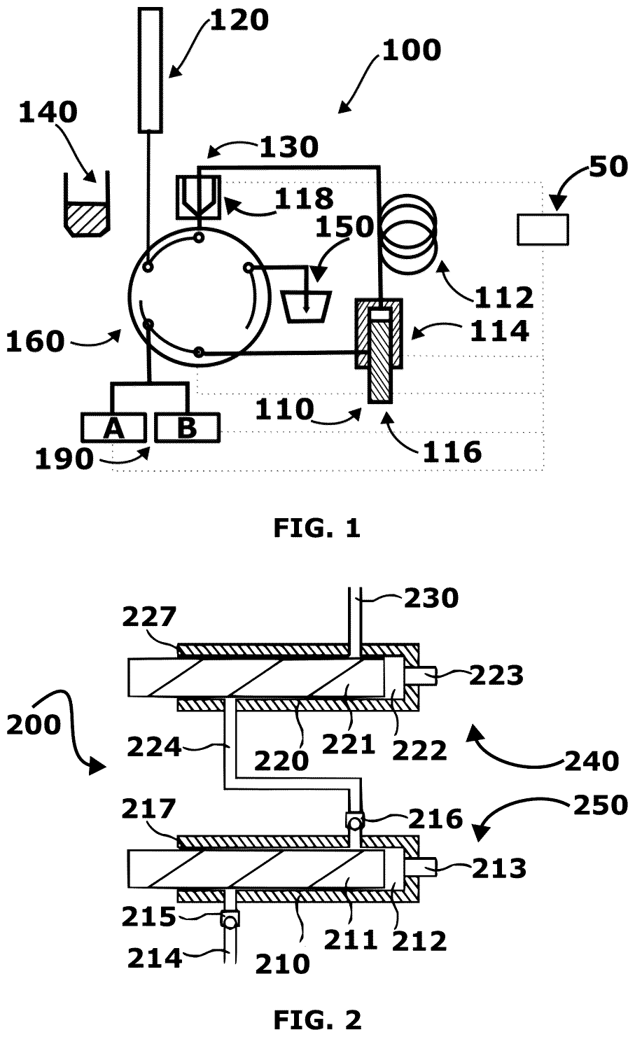

FIG. 1 schematically depicts components of an analytical system 100 such as an HPLC system 100. In simple terms, the analytical system 100 comprises a sampling device 110 which may also be referred to as metering device 110, which is usually in the form of an automated syringe. The metering device 110 may be used to pick up a sample, which is then injected to a column 120. For this purpose, the metering device 110 may be in (bidirectional) communication with a pump system 190 comprising pumps A, B. The metering device 110 is intended to create a pressure difference, thus, allowing a sample to be drawn from a container 140 such as a sample vial 140. Hence, the metering device 110 may comprise a sample pick-up means 130 such as a needle 130, which is fluidly connected to the sampling device 110, for instance, through a sample loop 112. Moreover, the system may also comprise a seat 118 for receiving the sample pick-up means 130, and a plurality of tubings to establish fluid connections between different components of the system 100. Furthermore, the system may comprise a separation column 120. Moreover, the system 100 may also comprise at least one controlling unit 50, which may simply be referred to as controller 50. Additionally, the system 100 may also comprise one or more waste collectors 150.

The system 100 may also comprise one or more distribution valves 160 comprising multiple ports, and the distribution valve may be configured for selectively connecting the ports in pairs, for example, for connecting adjacent ports. The one or more distribution valves 160 may comprise a stator and a rotor, and a rotatable drive. The stator may comprise a plurality of ports, and the rotor may comprise connecting elements to connect the ports to one another. The rotor can be rotated with respect to the stator, for instance, by means of the rotatable drive, so that the connecting elements may establish connections between different ports. The rotatable drive can include a motor, gearbox and encoder.

In one embodiment, the sampling device 110 may be a metering device 110. The metering device 110 may further comprise a housing 114 and a piston 116. The metering device 110 may also comprise a stepper motor or a drive device for moving the piston 116 in the housing 114.

The controller 50 can be operatively connected to other components. More particularly, the controller 50 may be operatively connected to the one or more distribution valves 160 (and more particularly to the rotatable drives thereof), to the sample pick up means 130, to, for example, a first and a second analytical pumps A, B, and to the sampling device 110 (more particularly, to the stepper motor of the sampling device 110).

The controller 50 can include a data processing unit and may be configured to control the system and carry out particular method steps. The controller 50 can send and/or receive electronic signals for instructions. The controller 50 can also be referred to as a microprocessor. The controller 50 can be contained on an integrated-circuit chip. The controller 50 can include a processor with memory and associated circuits. A microprocessor is a computer processor that incorporates the functions of a central processing unit on a single integrated circuit (IC), or sometimes up to a plurality of integrated circuits, such as 8 integrated circuits. The microprocessor may be a multipurpose, clock driven, register based, digital integrated circuit that accepts binary data as input, processes it according to instructions stored in its memory and provides results (also in binary form) as output. Microprocessors may contain both combinational logic and sequential digital logic. Microprocessors operate on numbers and symbols represented in the binary number system 100.

Furthermore, it should be understood that the system 100 may be configured to measure pressures at different locations of the system 100. For example, the system 100 may comprise a plurality of pressure sensors (not shown). For example, a first pressure sensor may be located in a first analytical pump A, and a second pressure sensor may be located in the sampling device 110. Further, a third pressure sensor may also be located in a second analytical pump B. These pressure sensors may also be operatively connected to the controller 50, and the controller 50 may use readings of these pressure sensors when controlling the operation of the system 100. The pressure sensors may be configured to measure the pressure directly. However, it should be understood that also other parameters may be measured and may be used to determine the respective pressures (and that such a procedure should also be understood as a pressure measurement and the components involved should be understood as pressure sensors). For example, it will be understood that when an analytical pump A, B supplies a solvent at a flow rate, the power consumption of the analytical pump A, B will also depend on the pressure at which it operates—the higher the operating pressure, the higher the power consumption. Thus, e.g., the power consumption of the pumps A, B may also be used to derive the pressure present at the pumps A, B. A corresponding consideration also applies for the sampling device 110: The higher the pressure present in the sampling device 110, the higher the power consumption when the piston 116 is moved further into the housing 114. Thus, the system 100 may generally be configured to measure pressures present at different locations of the system 100.

As depicted, the system 100 comprises a pump system 190 upstream of the distribution valve 160. The pump system 190 comprises a first pump A and a second pump B supplying different solvents. Thus, the pump system 190 supplies a solvent mixture. The individual pumps A and B, which may also be referred to as pump units A and B nay run at different speeds. By means of the different speeds, the proportion of the resulting solvent mixture supplied to downstream components may be adjusted, e.g., from a range of 0% of a first solvent and 100% of a second solvent to 100% of the first solvent and 0% of the second solvent.

FIG. 2 schematically depicts a pump 200, which may also be referred to as pump unit 200. It will be understood that each pump unit A, B depicted in FIG. 1 may be realized as the pump unit 200 depicted in FIG. 2. The pump unit 200 comprises a double piston mechanism 240, 250. As an example, FIG. 2 shows a double piston pump 200 with mechanism pistons 240, 250 arranged in series. In another embodiment, the pump 200 may comprise double piston mechanisms 240, 250 arranged in parallel. Moreover, each of piston mechanisms 240, 250 comprises a pump head 210, 220, and a piston 211, 221 movably mounted in the pump head 210, 220 respectively. This results in a free volume 212, 222 in each pump heads 210, 220. Moreover, pistons 211, 221 are sealed against pump head 210, 220 respectively, for example, by means of a seal 217, 227. Each displacement mechanism 240, 250 comprises an inlet 214, 224 as well as an outlet 218, 228. The upstream displacement mechanism 250 may further comprise an inlet valve assembly, 215 as well as an outlet valve assembly 216. Each displacement mechanism 240, 250 may further comprise a pressure senor 213, 223.

The pump 200 may be used to supply a fluid, for example, downstream of T-piece, such a liquid for using in HPLC systems 100. For instance, the pump 200 may be part of a pump system, such as the pump system 190 as depicted in FIG. 1, comprising a first pump unit and a second pump unit, which may be used to provide fluids under pressure and at a flow rate. In one embodiment, one pump 200 may be used to provide, for example, an aqueous solution and another pump 200 may be used to provide an organic solution such as acetonitrile. Moreover, the aqueous solution and the organic solution may be provided at different flow rates. In one embodiment, the pump system 190 may further comprise a mixer unit (not shown) configured to mix fluids, for instance, the aqueous solution and the organic solution.

In more simple words, the pump 200 comprises double pistons 240, 250 which may be configured to change a flow rate of a fluid, which is achieved by movement of the pistons, for instance, as results of the piston assuming a first position and second position such as a left-most position and right-most position, which when the pump alternates the pistons from the left-most position to the right-most position, allows pumping of the fluids. In a pump system comprising two or more pumps, each pump may deliver a fluid different from the fluids delivered by the other pumps at a variable flow rate.

The pump 200 may comprise a controller (not depicted) that operates the pump 200 in the manner according to embodiment of the present invention. In one embodiment, the controller of the pump 200 may also be the controller 50 depicted in FIG. 1, which may more particularly be configured to control the pump 200, inter alia, the pump speed. Each of the pistons 240, 250 of pump 200 may be operated with a certain speed. The overall pump speed may be a sum of the speeds of the two pistons 240, 250. A detailed description of how a pump unit as depicted in FIG. 2 works in general may, for example, be found in DE 10 2017 115 242 A1.

It will be understood that the system 100, which may also be referred to as chromatography system 100, may be used for chromatographic analysis. For this, a sample may be picked up by means of the metering device 116 and may then be injected into the column 120. A solvent mixture may be delivered by means of the pump system 190, causing constituents of the sample to be released from the column 120 at different times. In this process, the solvent mixture delivered by the pump system 190 may be varied over time, which is referred to as a gradient procedure.

With such a system 100, a plurality of chromatographic runs may be performed, e.g., two or more chromatographic runs (which may also be referred to as analytical runs).

At the start of a first analytical run of a measurement series, drives of the pump unit 200 are generally unsynchronized. That means that for each pump unit A, B and for each piston mechanism 240, 250 of each pump unit A, B, the piston position is generally undefined.

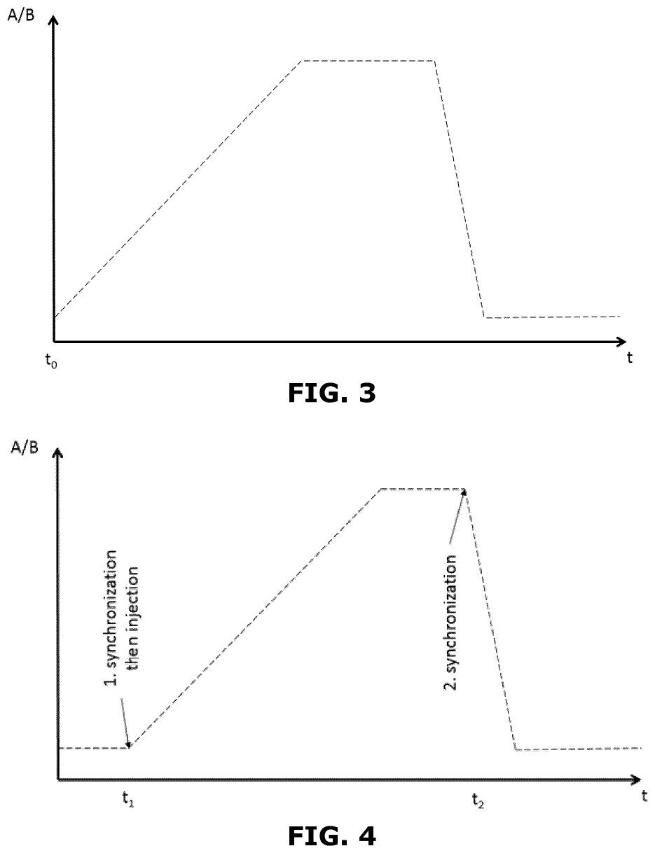

The measurement series follows a measurement protocol that is defined by fixed time sequences, i.e., all individual steps always run at the same time with regard to the injection time. The first analytical run follows the measurement protocol, and the measurement protocol can be stored in a control computer or a control unit of a HPLC system 100. The system, which may also be referred to as analytical device may for instance follow a plurality of steps. These steps may, inter alia, comprise the initiation of the measurement protocol and provision of the start conditions to one or all components or to one or all devices in the analytical system 100 such as mixing ratio of pump(s), flow of the pump(s). For example, a sample may be injected at an injection time tᵢₙⱼ. With regard to FIG. 3, the injection time tᵢₙⱼ may be at t₀. Overall, it will be understood that FIG. 3 depicts a mixing ratio of solvents A and B. In the embodiment depicted in FIG. 3, solvent B, which may, for instance, be a polar solvent such as water and solvent A, which may, for instance, be a less polar solvent such as acetonitrile. Shortly after the sample is injected, the mixing ration A/B is low, i.e., a relatively great amount of solvent B is supplied and a relatively small amount of solvent B is supplied. The ratio A/B is successively increased, i.e., the ratio of solvent A is increased. It will be understood that at t₀, where solvent B is supplied with a relatively high flow rate (a solvent B with a relatively low flow rate), the pump supplying solvent B (for sake of simplicity, this pump is also referred to as pump B) runs relatively fast (and pump A runs relatively slow). Vice versa, after the ratio of A/B has been increased, pump A runs relatively fast and pump B runs relatively slow. After the increase of ratio A/B, this ratio may be kept constant and may then be decreased again, where it is again held constant as a low A/B ratio, before the subsequent run starts. It will thus be understood that the measurement protocol particularly relates to the timing of the solvent delivery, i.e., the time dependent curve of the ratio A/B, as depicted in FIG. 3.

In one embodiment, the pumps A, B may determine which of the two pumps is currently faster. Again, with reference to FIG. 3, it will be understood that pump B will typically be faster at t₀, while pump A will typically be faster at a time when the plateau of A/B has been reached.

Reference will now be made to FIG. 4. It will be appreciated that FIG. 4 mostly corresponds to FIG. 3. However, FIG. 4 also indicates times t₁ and t₂, and it should be understood that t₁ is equal to t₀ or shortly prior to t₀.

With reference to FIG. 4 and more particularly time t₁, the pump system 190 may inform the system that it will be proceeding to move to a synchronization position, so that the system may prompt the metering device 110 into a waiting state until a response from the pump(s) A, B is received. While in the waiting state, the metering device 110 does not inject sample(s). Once the pump system 190 including pumps A, B has reached the t1 position for synchronization, the system prompts the metering device 110 out of the waiting state to proceed to inject the sample. That is, there is a first synchronization position at t1 shortly before the sample is injected towards the separation column.

Once the sample has been injected, the system proceeds to run the measurement protocol. Again, this particularly includes the time dependent delivery of the solvent mixture over time. In one embodiment, the pump system 190 may detect that a measurement log has now reached a time t2, where the initially slow pump is now running fast, and is switched back to a slow delivery mode. With reference to FIG. 4, it will be understood that this is at time t2. At this time, pump B is running relatively slow and pump B is running relatively fast. Hence, the pump system 190 may be configured to inform the system that the pump system 190 is ready to return to a synchronization position. Consequently, the system pauses the measurement log and prompts the pump system 190 including pumps A, B to reach a position for synchronization.

In particular, at time t1, when the pump unit B runs relatively fast, this pump unit B may be synchronized, and at time t2, when the pump unit A runs relatively fast, this pump unit A may be synchronized. Thus, in each run, both pump units A, B may be synchronized, leading to more reproducible runs. It will be understood that typically, the pump units A, B will be synchronized when there are running relatively fast. This may be advantageous, as it allows the synchronization to be performed relatively quickly. For example, this may be more advantageous compared to the situation that, e.g., both pump units A, B would be synchronized at t1. At this time t1, pump unit A runs relatively slowly, such that it would take an excessive amount of time to synchronize this pump unit at t1.

After the second synchronization at t1, the system re-takes the measurement protocol, i.e., the measurement protocol is continued. A signal is sent from the pump system 190 to the metering device 110, which prompts the metering to prepare for a subsequent injection, i.e., to draw up a sample and proceed to the injection site. Then, the measurement protocol culminates for this analytical run, and a (subsequent) measurement in the measurement series starts.

In following the above-described steps, for a pump system comprising pump units A and B, the four piston mechanisms 240, 250 of the pump units A and B are synchronized from the second measurement. Typically, the first measurement does not meet the requirements of synchronization. However, the first measurement is generally used to run in the measuring system and is therefore not evaluated and can be neglected.

Again, FIGS. 3 and 4 schematically depict examples a mixing ratio A/B vs time t for an analytical run.

In simple terms, the term mixing ratio A/B is intended to refer to a mixture of a solvent or solution A and a solvent or solution B, which are mixed in varying proportions for an analytical run, for example, such as the conditions necessary in relation to a given elution time or a given selectivity, or any combination thereof. Solvent B may for instance represent an aqueous solution, and solvent A may for example represent an organic solution.

A mixing ratio A/B may allow achieving a proper degree of general polarity of a mobile phase for a given HPLC column and set of analytes. This degree of general polarity of the mobile phase may also be referred to as solvent strength. For example, for polar sorbents such as silica, a more polar solvent is generally considered a stronger solvent and as a result, the analytical run exhibits a shorter elution time. For this reason, the strength of a solvent may also be defined as the ability of a solvent to elute one or more compounds more quickly from a given column. Thus, the strength of solvent is to be considered as being compound specific. Contrary to polar sorbents, for a non-polar sorbent, such as the sorbents typically utilized in reversed phase HPLC, the strength order is reversed. This means that a non-polar compound is then considered the stronger solvent (and not the polar solvent).

Controlling the mixing ratio A/B is particularly advantageous, as it may consequently allow to control the elution of analytes. For example, if analytes elute rapidly, i.e., if the compounds leave the column too fast, their separation would only be achieved poorly, i.e., the compounds would not be separated well. However, if analytes elute extremely slow, elution would take longer times (if not too long time) and as results, chromatographic peaks would broaden to a point of being too broad. Furthermore, controlling the mixing ratio A/B may also allow controlling or regulating the selectivity.

FIG. 3 depicts an example of a temporal sequence of a mixing ratio A/B vs time t. Generally, a sample is injected at an initial time t0 into a measuring system 100. In general, there is the possibility to synchronize the drive, which conveys rapidly at the beginning to of an analytical run, i.e., at the moment of injection. Then it is possible to direct the programmed time-dependent mixing ratio A/B, as depicted in FIG. 1. In general, the pump unit or drive with an organic solution, which conveys little at the beginning, is accelerated, and another pump unit or drive with an aqueous solution is slowed down, so that at the end of an analytical run, the initially slow drive now conveys quickly and vice versa.

For a given analytical run, there is typically a phase where a mixing ratio A/B is kept constant. This serves, for instance, to wash off contaminations from a column. Once the analytical column is washed, it can then be switched back to an original mixing ratio that was valid at the moment of injection. This is particularly advantageous, as it ensures that the analytical column is rinsed back to its original chemical conditions. At the moment just before the switchover or in the moment before the changeover, the speed of the two drives is synchronized. The moment of the switchover may be recognized by the fact that a rapid change in the mixing ratio takes place, which is atypical for analytical runs.

It should be understood that the analytical column is merely exemplary, and it may also be used to wash other types of columns, such a separation column, a trap column, or even other component of an analytical device such as other components of an HPCL system 100.

FIG. 4 schematically depicts a synchronization of a respective fast pump conveying fluids A and B at times t1 and t2 with respect to the time of injection. In simple terms, it is possible to perform a first synchronization at a first time t1, and subsequently executing an injection. A second synchronization may be performed at a second time t2. Thus, the system may be prepared for a second run including a second injection. From the second injection of a repeating series of measurements, the two drives run synchronized.

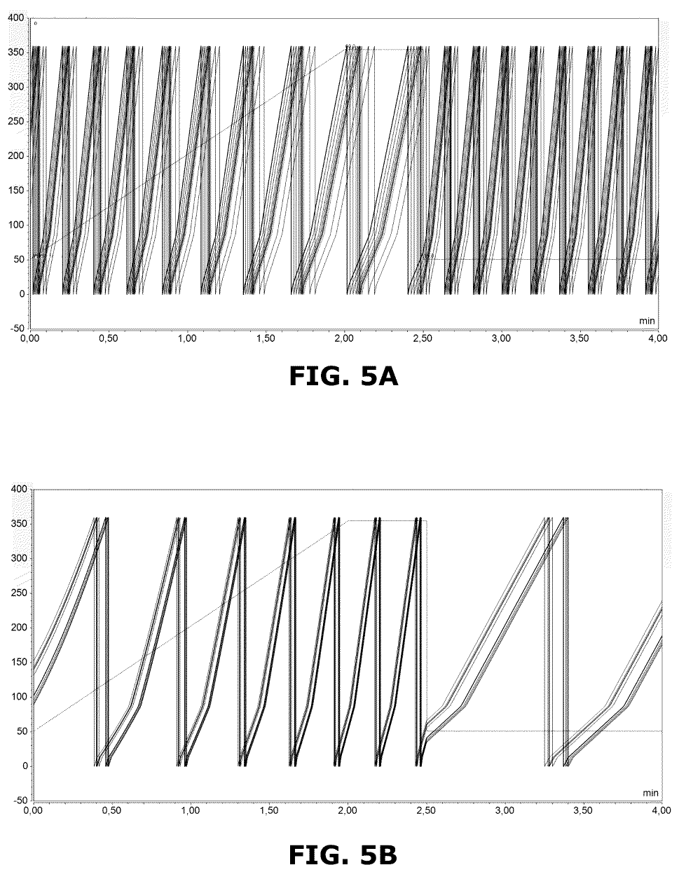

FIGS. 5A and 5B depict examples of the piston positions while performing the gradient (mixing ratio A/B) of the analysis of 11 superimpose analytical runs. FIG. 5A depicts the positions of a first pump unit or drive, and FIG. 5B depicts the positions of a second pump unit or drive. In simple words, FIGS. 5A and 5B represent a state of the pump system 190 without implementation of any synchronization steps.

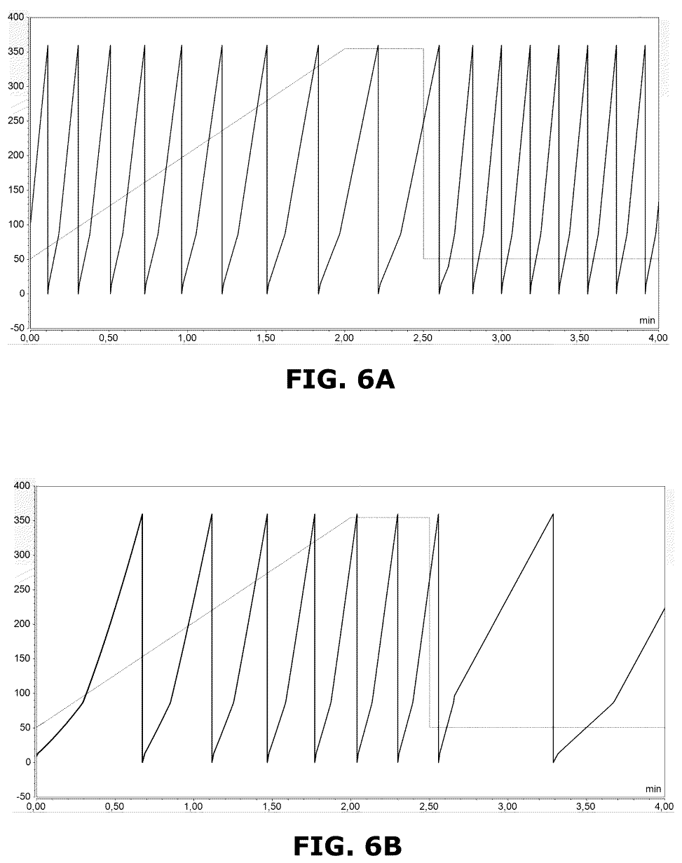

FIGS. 6A and 6B depict examples of the piston position while performing the gradient (mixing ratio A/B) of 11 superimposed analytical runs with the synchronization of an embodiments of the present invention. FIG. 6A depicts the positions of a first pump unit or drive, and FIG. 6B depicts the positions of a second pump unit or device. In FIGS. 6A and 6B, synchronization was performed at the beginning of the analytical run, i.e., at a time t0, and at the end of a time t of 2.5 minutes, respectively.

Contrary to what is observed in FIGS. 5A and 5B, FIGS. 6A and 6B depicts an apparent single line, even though, in both situations (that of FIGS. 5A and 5B, and FIGS. 6A and 6B) the same number of analytical runs are depicted, as well as the same conditions such as the same total flow of 0.5 ml/min, and a gradient procedure where the ratio of solvent B is increased from 15% to 60%. Overall, the depicted embodiment results in the synchronization of the drives.

While in the above, a preferred embodiment has been described with reference to the accompanying drawings, the skilled person will understand that this embodiment was provided for illustrative purpose only and should by no means be construed to limit the scope of the present invention, which is defined by the claims.

Whenever a relative term, such as “about”, “substantially” or “approximately” is used in this specification, such a term should also be construed to also include the exact term. That is, e.g., “substantially straight” should be construed to also include “(exactly) straight”.

Whenever steps were recited in the above or also in the appended claims, it should be noted that the order in which the steps are recited in this text may be accidental. That is, unless otherwise specified or unless clear to the skilled person, the order in which steps are recited may be accidental. That is, when the present document states, e.g., that a method comprises steps (A) and (B), this does not necessarily mean that step (A) precedes step (B), but it is also possible that step (A) is performed (at least partly) simultaneously with step (B) or that step (B) precedes step (A). Furthermore, when a step (X) is said to precede another step (Z), this does not imply that there is no step between steps (X) and (Z). That is, step (X) preceding step (Z) encompasses the situation that step (X) is performed directly before step (Z), but also the situation that (X) is performed before one or more steps (Y1), . . . , followed by step (Z). Corresponding considerations apply when terms like “after” or “before” are used.

1. A method comprising
a first pump unit delivering a first flow of a first solvent at a first flow rate, and
a second pump unit delivering a second flow of a second solvent at a second flow rate,
wherein the first flow rate and the second flow rate vary over time in a manner reoccurring in a plurality of runs, wherein the plurality of runs comprise at least a first run and a second run,
wherein the method further comprises
in the first run, at a first process stage of the first run when the first flow rate exceeds the second flow rate, the first pump unit assuming a first pump unit state,
(a) in the second run, at a first process stage of the second run corresponding to the first process stage of the first run, wherein the first flow rate exceeds the second flow rate at the first process stage of the second run, setting the first pump unit to the first pump unit state,
in the first run, at a second process stage of the first run when the second flow rate exceeds the first flow rate, the second pump unit assuming a second pump unit state, and
(b) in the second run, at a second process stage of the second run corresponding to the second process stage of the second run, wherein the second flow rate exceeds the first flow rate at the second process stage of the second run, setting the second pump unit to the second pump unit state.

2. The method according to claim 1, wherein the method is performed in a chromatography system comprising the first pump unit and the second pump unit, wherein
the first pump unit comprises at least one piston and wherein the first pump unit state is defined by a position of at least one of the at least one piston of the first pump unit, wherein the at least one piston of the first pump unit is a plurality of pistons and preferably two pistons, and
the second pump unit comprises at least one piston and wherein the second pump unit state is defined by a position of at least one of the at least one piston of the second pump unit, wherein the at least one piston of the second pump unit is a plurality of pistons and preferably two pistons.

3. The method according to claim 1, wherein the method further comprises injecting a sample into an analytical path of the chromatography system in the first run and in the second run, wherein for each run, the first process stage is before injecting the sample into the analytical path, wherein for each run, the first pump unit assumes the first pump unit state or is set to the first pump unit state at a time preceding a respective injection time of the run by not more than 5 minute, preferably by not more than 3 minutes, more preferable by not more than 1 minute.

4. The method according to claim 1, wherein in each run, a ratio between the second flow rate and the first flow rate is constant for an amount of time prior to the second process stage, wherein the amount of time is in the range of 1 and 180 minutes, preferably between 3 and 120 minutes, more preferably between 5 and 60 minutes.

5. The method according to claim 1, wherein the plurality of runs comprises more than two runs, wherein the method further comprises performing steps corresponding to steps (a) and (b) for the runs after the second run, wherein the runs comprise at least 3 runs, preferably at least 7 runs.

6. The method according to claim 1, wherein method comprises varying the first flow rate over time in a manner reoccurring in a plurality of runs, wherein
the first flow rate at an initial t0 is different from the first flow rate at a subsequent time tn by at least one complete revolution of a pump unit drive, wherein t=V_{S}/<F>, wherein is t is time, V_{S} is the stroke volume of the pump unit and <F> is the mean value of the pump unit flow between t0 and tn, and
wherein the method comprises varying the second flow rate over time in a manner reoccurring in a plurality of runs, wherein
the second flow rate at an initial t0 is different from the second flow rate at a subsequent time tn by at least one complete revolution of a pump unit drive, wherein t=V_{S}/<F>, wherein is t is time, V_{S} is the stroke volume of the pump unit and <F> is the mean value of the pump unit flow between t0 and tn,
wherein the method comprises providing a total flow rate between 0.001 ml/min and 20 ml/min, preferably between 0.005 ml/min and 15 ml/min, more preferably between 0.01 ml/min and 10 ml/min.

7. The method according to claim 1, wherein the method comprises
determining a current operating speed of the at least two pistons of the first pump unit, wherein the method further comprises determining which of the at least two pistons comprise the faster current operating speed,
determining a current operating speed of the at least two pistons of the second pump unit, wherein the method further comprises determining which of the at least two pistons comprise the faster current operating speed,
prompting the first pump unit and/or the second pump unit to a synchronization position,
detecting a running speed of each of the at least one piston of first pump unit at a time t1,
determining which of the at least one piston of the first pump unit currently drives fastest,
detecting a running speed of each of the at least one piston of the second pump unit at a time t1, and
determining which of the at least one piston of the second pump unit currently drives fastest.

8. The method according to claim 1, wherein the method comprises detecting
a measurement log reaching time t2;
a running speed of the at least one piston of the first pump unit; and
switching the at least one piston of the first pump unit back to a slow delivery mode.

9. The method according to claim 1, wherein the method comprises detecting
a measurement log reaching time t2;
a running speed of the at least one piston of the second pump unit; and
switching the at least one piston of the second pump unit back to a slow delivery mode.

10. The method according to claim 1, wherein the method comprises at least one of:
pausing the measurement log,
resuming the measurement log,
detecting that the first pump unit reaches a position for synchronization,
detecting that the second pump unit reaches a position for synchronization,
resuming the measurement log when the first pump unit has reached its position for synchronization,
resuming the measurement log when the second pump unit has reached its position for synchronization.

11. The method according to claim 1, wherein the method comprises finalizing a first analytical run, and carrying out the method according to any of the preceding method claims for performing a measurement in series, wherein the measurement in series comprises at least two subsequent analytical runs.

12. A pump system comprising a first pump unit, a second pump unit and a control unit, wherein the control unit is programmed to cause the pump system to perform the method according to any of the preceding claims, wherein the first pump unit comprises at least one piston and the second pump unit comprises at least one piston.

13. The pump system according to claim 12, wherein the at least one piston of the first unit is a plurality of pistons, wherein the plurality of pistons comprises a double piston configuration, and wherein the at least one piston of the second pump unit is a plurality of pistons, wherein the plurality of pistons comprises a double piston configuration, wherein each of the at least one piston of the first pump unit and/or the second pump unit comprises a piston with a variable accommodation volume, wherein the first pump unit pump is a pump unit for liquid chromatography and the second pump unit is a pump unit for liquid chromatography.

14. A chromatography system comprising the pump system according to claim 12, wherein the system comprises
a sampling device adapted to suck in a sample,
at least one column,
at least one mixer unit,
at least one control unit bidirectionally connected to at least one component of the system,
a sample pick-up means,
a seat for receiving the sample pick-up means,
at least one distributor valve comprising a plurality of ports and a plurality of connecting element for changeably connecting the ports of the at least one distributor valve, and
a waste reservoir, wherein the system is configured to assume a configuration wherein the waste reservoir is fluidly connected to at least one of the at least one column.

15. The chromatography system according to the claim 14, wherein the system is a liquid chromatography system, wherein the system is configured to be pressurized to a first pressure exceeding ambient pressure by at least 100 bar, preferably by at least 1000 bar, more preferably by at least 1500 bar.
